(19) United States
(12) Patent Application Publication
(10) Pub. No.: US 2018/0099601 A1
(43) Pub. Date: Apr. 12, 2018

(54) HYDRAULIC CRANE FOR VEHICLE

(71) Applicant: FORD GLOBAL TECHNOLOGIES, LLC, Dearborn, MI (US)

(72) Inventors: Diego Clemente Martinez Romero, Puebla (MX); Francisco Jose Fernandez Sanchez, Puebla (MX); Jose Antonio Segura Salgado, Puebla (MX)

(21) Appl. No.: 15/286,637

(22) Filed: Oct. 6, 2016

(51) Int. Cl. B60P 1/54

(52) U.S. Cl. CPC B60P 1/5495; B60P 1/5433

(57) ABSTRACT

A stowable hydraulic crane for a vehicle load bed includes a boom, a mast configured to pivot between a deployed configuration and a stowed configuration in a load bed sidewall receiver, and a base. A hydraulic member is provided to tilt the boom. The base includes a locking member for retaining the mast in the deployed configuration.

### TECHNICAL FIELD

This disclosure relates generally to accessories for vehicles. More particularly, the disclosure relates to a small stowable hydraulic crane accessory for a vehicle such as a truck.

### BACKGROUND

As is known, a pickup truck is a vehicle having a vehicle-rear disposed cargo area or load bed which is convenient for carrying a number of items. Often, the items which the pick-up truck and load bed are capable of carrying exceed the ability of a user to lift them safely to place them in or remove them from the load bed. Accordingly, there is a need for accessories for safely lifting heavy items for placement in a pickup load bed.

To solve this and other problems, the present disclosure relates to a hydraulic crane for use with a vehicle such as a pickup truck. Advantageously, the described hydraulic crane is configured for conveniently stowing in a portion of the pickup load bed.

### SUMMARY

In accordance with the purposes and benefits described herein, in one aspect a stowable hydraulic crane for a vehicle load bed is provided. The stowable hydraulic crane comprises a boom and a mast configured to pivot between a deployed configuration and a stowed configuration held in a load bed sidewall receiver. The stowable hydraulic crane further comprises a base for pivotally holding the mast and an actuator configured for attachment at a first end to the mast and at an opposed second end to the boom.

The mast may carry a pivoting receiver for the boom. In embodiments, the pivoting receiver includes a plurality of apertures alignable with a plurality of cooperating apertures defined in the boom. At least one fastener may be provided configured to pass through a pivoting receiver aperture and an aligned cooperating boom aperture to attach the boom to the mast. The base may be mounted in the load bed sidewall receiver and configured to rotate about a base longitudinal axis. The base may further include a locking member for retaining the mast in the deployed configuration. In embodiments, the actuator is a hydraulic member comprising a hydraulic cylinder, a pump body, and a pump handle.

In other aspects, vehicle load beds including a stowable hydraulic crane and vehicles including such load beds are described.

In the following description, there are shown and described embodiments of the disclosed stowable hydraulic crane. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed stowable hydraulic crane, and together with the description serve to explain certain principles thereof. In the drawing:

FIG. 1 depicts a vehicle including a stowable hydraulic crane according to the present disclosure, held in a stowed configuration;

FIG. 2 depicts the stowable hydraulic crane of FIG. 1 in a deployed configuration;

FIG. 3A shows in isolation a top view of a base for a stowable hydraulic crane according to the present disclosure;

FIG. 3B shows a side view of the base of FIG. 3A;

FIG. 4A shows in isolation a rear view of a mast for a stowable hydraulic crane according to the present disclosure;

FIG. 4B shows a side view of the mast of FIG. 4A;

FIG. 5 shows in isolation a side view of a boom for a stowable hydraulic crane according to the present disclosure; and

FIG. 6 shows a hydraulic member for a stowable hydraulic crane according to the present disclosure.

Reference will now be made in detail to embodiments of the disclosed stowable hydraulic crane, examples of which are illustrated in the accompanying drawing figures.

### DETAILED DESCRIPTION

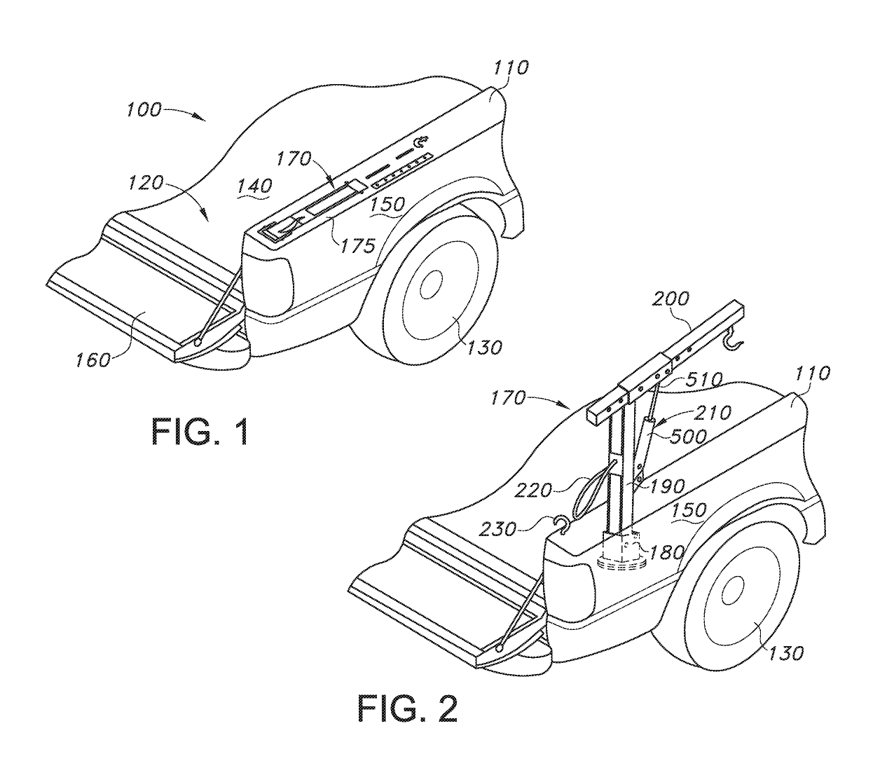

With reference to FIG. 1 there is shown a vehicle 100 including a passenger cabin 110, a load bed 120, and ground engaging wheels 130. The load bed 120 includes a load floor 140, and opposed load bed side walls 150. A tailgate 160 serves to prevent items held in the load bed 120 from inadvertently dislodging from the vehicle 100. A stowable hydraulic crane assembly 170 is shown held in a substantially horizontal stowed configuration within one or more recesses 175 defined one of the load bed side walls 150. As will be appreciated, a single recess 175 may be provided (embodiment not shown) such as a side-wall mounted covered container including retainers for holding all components of the stowable hydraulic crane 170. Alternatively, as shown in the drawing multiple recesses 175 may be provided, each specifically dimensioned and configured to hold a component of the stowable hydraulic crane 170.

With reference to FIG. 2, a stowable hydraulic crane 170 is shown, held in a substantially vertical deployed configuration. As will be described in greater detail below, the stowable hydraulic crane 170 includes a base 180, a mast 190, a boom 200, and a boom actuator 210. A handle 220 may be included for raising and lowering the mast 190. A cooperating retainer 230 may be provided on the load bed side wall 150 or in an interior of a recess 175 (embodiment not shown) for capturing the handle 220 to assist in retaining the stowable hydraulic crane 170 in the deployed configuration as shown in the drawing.

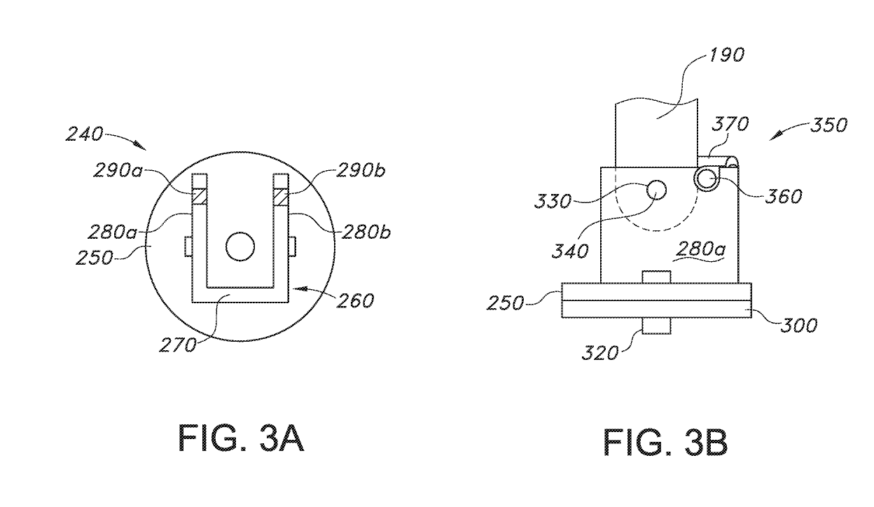

Various elements make up the stowable hydraulic crane 170. With reference to FIG. 3A, a rotating base 240 is depicted in top view, including a rotating platform 250 and a mast receiver 260. As shown, the mast receiver 260 is substantially U-shaped to define a square or rectangular interior, and includes back wall 270 and side walls 280a, 280b. Each side wall 280a, 280b includes a notch or groove 290a, 290b dimensioned to receive a locking member as will be described below. As will be appreciated, the mast receiver 260 may be provided any suitable interior dimension and/or configuration in accordance with an exterior dimension/configuration of the mast 190. Accordingly, the specific configurations shown in FIG. 3A should not be taken as limiting.

Turning to FIG. 3B, the rotating platform 250 is configured to rotate by including a fixed plate 300 and a rotating plate 310, rotatably attached by a pivot 320. The fixed plate 300 may be attached to a portion of the load bed side wall 150, such as to an interior surface of a recess 175. Each side wall 280a, 280b includes an aperture 330 which receives a pivot 340 therethrough. The mast 190 includes cooperating apertures (not visible in this view) which likewise receive the pivot 340 therethrough. As will be appreciated, this allows the mast 190 to pivot between the stowed and deployed configurations shown in FIGS. 1 and 2, simply by raising and lowering using handle 220.

A locking member 350 may be included, comprising a locking rod 360 configured and dimensioned to fit within each notch or groove 290a, 290b and to extend across the gap between side walls 280a, 280b. Thus, when mast 190 is raised to the substantially vertical horizontal position shown in FIG. 2, placing locking rod 360 in grooves or notches 290a, 290b will prevent the mast from inadvertently translating back to the substantially horizontal stowed configuration of FIG. 1. For further security, a locking cover 370 may be provided for each notch or groove 290a, 290b to prevent inadvertent displacement of the locking rod 360. As will be appreciated, one or both of locking member 350 and retainer 230 may be provided to ensure that the mast 190, once placed in the substantially vertical deployed configuration, is not inadvertently dislodged from that configuration.

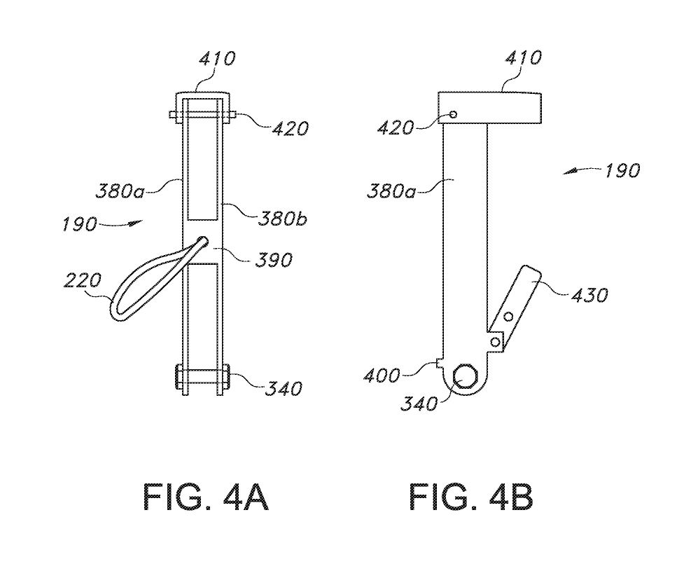

FIG. 4A shows a rear view of a mast 190 for use with the stowable hydraulic crane 170. The mast 190 may be a solid body (embodiment not shown) or, as shown in the drawing figure be defined by opposed struts 380a, 380b reinforced by one or more cross-bars 390. As shown, cross-bar 390 provides a convenient point for attachment of the handle 220. A further advantage of this configuration is savings in weight and materials, and accordingly in cost. In still other possible embodiments, the mast 190 may be defined by a hollow body having a square, rectangular, or cylindrical cross-section (embodiments not shown).

As shown in FIG. 4B, the mast 190 may further include a stop 400 to prevent translation of the stowable hydraulic crane 170 beyond the substantially vertical configuration shown in FIG. 2. A pivoting boom receiver 410 is provided, attached to an upper portion of the mast 190 by a pivot 420. The pivoting boom receiver 410 will be described in greater detail below. The mast 190 further includes a holder 430 for a boom actuator, which will also be described in greater detail below.

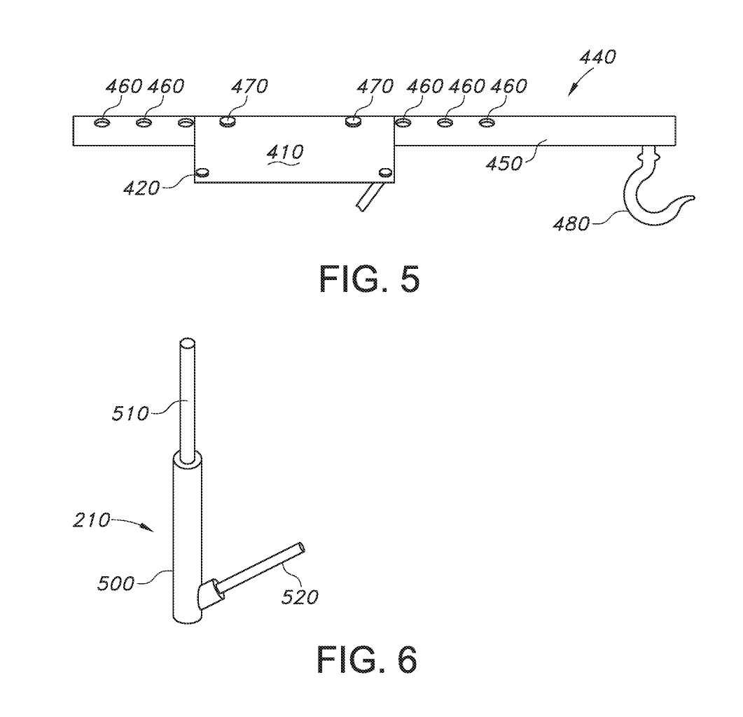

FIG. 5 depicts a boom 440 for the described stowable hydraulic crane 170. As shown, the boom 440 includes a boom arm 450 having a plurality of spaced apertures 460 defined therethrough. The pivoting boom receiver 410 includes cooperating alignable apertures 470 defined therethrough. As will be appreciated, a length of the boom arm 450 may be adjusted by simply aligning boom arm apertures 460 with the desired pivoting boom receiver apertures 470, and securing them in place by suitable fasteners such as bolts or screws and cooperating nuts.

A suitable device for capturing items to be lifted into/removed from the vehicle load bed 120 is provided at a distal end of the boom arm 450, in the depicted embodiment being a hook 480. However, as will be appreciated any suitable such device may be provided, including without intending any limitation hooks, block and tackle, magnets, grapples, mechanical claws, and any other such capturing device known to be used in conjunction with cranes for lifting and moving items.

FIG. 6 shows one possible embodiment of a boom actuator 210, being a hydraulic actuator including a housing 500, a linearly displaceable hydraulic cylinder 510, and a pump handle 520 for causing the linearly displaceable hydraulic cylinder 510 to extend and retract. As will be appreciated by reference to FIGS. 2 and 4B, the boom actuator 210 is attached at a first end to the holder 430 and at a second end to a portion of the boom arm 450. Thus, in conjunction with the pivoting boom receiver 410 actuating the boom actuator 210 allows raising/lowering the boom arm 450 to likewise raise/lower any items captured by the hook 480.

Thus, by the foregoing description there is provided a convenient, useful stowable hydraulic crane 170 for use by a vehicle owner in the manner described above. When not needed, the user need only dismantle a portion of the crane, i.e. remove the boom arm 450 and boom actuator 210, disengage the locking member 350 and/or disengage the handle 220 from the retainer 230. Then, the mast 190 may be folded down into a recess 175, and the boom arm 450 and boom actuator 210 may be placed in a same or a different recess 175 for stowage.

Obvious modifications and variations are possible in light of the above teachings. For example, the hook 480 or other device may be directly attached to the boom arm 450 as shown in the drawing figures, or may be attached by an extendable cable or rope which is in turn coiled about a rotatable reel or drum. Still further, the hook 480 or other device and boom arm 450 may be configured such that the hook can slide up and down a length dimension of the boom arm, as is known for a gantry crane. Also, rather than a boom actuator 210 including a pump handle 520 as shown in the drawings, the boom actuator may be operatively connected to a pump such as a hydraulic pump, allowing remote actuation of the boom arm 450 such as from an interior of the vehicle passenger cabin 110 or elsewhere. Still more, rather than dismantling the crane components as described above, the stowable hydraulic crane 170 may simply be folded, such as by pivoting the boom arm 450 and boom actuator 210 whereby each is aligned in a substantially coplanar orientation and then folding the mast 190 down into a recess 175 as described above. All such modifications and variations are within the scope of the appended claims when interpreted in accordance with the breadth to which they are fairly, legally and equitably entitled.

What is claimed:

1. A stowable hydraulic crane for a vehicle load bed, comprising:
a boom;
a mast configured to pivot between a deployed configuration and a stowed configuration held in a load bed sidewall receiver;
a base; and
a boom actuator.

2. The stowable hydraulic crane of claim 1, wherein the mast carries a pivoting receiver for the boom.

3. The stowable hydraulic crane of claim 2, wherein the pivoting receiver includes a plurality of apertures alignable with a plurality of cooperating apertures defined in the boom.

4. The stowable hydraulic crane of claim 3, further including at least one fastener configured to pass through a pivoting receiver aperture and an aligned cooperating boom aperture to attach the boom to the mast.

5. The stowable hydraulic crane of claim 1, wherein the mast is pivotally attached to the base.

6. The stowable hydraulic crane of claim 1, wherein the base is mounted in the load bed sidewall receiver and configured to rotate about a base longitudinal axis.

7. The stowable hydraulic crane of claim 6, wherein the base further includes a locking member for retaining the mast in the deployed configuration.

8. The stowable hydraulic crane of claim 1, wherein the boom actuator comprises a hydraulic actuator.

9. A stowable hydraulic crane for a vehicle load bed, comprising:
a boom;
a rotating base mounted in a load bed sidewall receiver;
a mast carrying a pivoting receiver for the boom and pivotally attached to the rotating base for translation between a deployed configuration and a stowed configuration held in the load bed sidewall receiver; and
a boom actuator for tilting the boom.

10. The stowable hydraulic crane of claim 9, wherein the pivoting receiver includes a plurality of apertures alignable with a plurality of cooperating apertures defined in the boom.

11. The stowable hydraulic crane of claim 10, further including at least one fastener configured to pass through a pivoting receiver aperture and an aligned cooperating boom aperture to attach the boom to the mast.

12. The stowable hydraulic crane of claim 9, wherein the base further includes a locking member for retaining the mast in the deployed configuration.

13. A vehicle body, comprising:
a passenger cabin;
a load bed including one or more load bed pillars; and
a stowable hydraulic crane, comprising:
a boom;
a base rotatably mounted to a one of the one or more load bed pillars;
a mast configured to pivot between a deployed configuration and a stowed configuration held in a load bed sidewall receiver; and
a boom actuator for tilting the boom.

14. The stowable hydraulic crane of claim 13, wherein the mast carries a pivoting receiver for the boom.

15. The stowable hydraulic crane of claim 14, wherein the pivoting receiver includes a plurality of apertures alignable with a plurality of cooperating apertures defined in the boom.

16. The stowable hydraulic crane of claim 15, further including at least one fastener configured to pass through a pivoting receiver aperture and an aligned cooperating boom aperture to attach the boom to the mast.

17. The stowable hydraulic crane of claim 13, wherein the mast is pivotally attached to the base.

18. The stowable hydraulic crane of claim 17, wherein the base further includes a locking member for retaining the mast in the deployed configuration.

19. The stowable hydraulic crane of claim 13, wherein the boom actuator comprises a hydraulic actuator.

20. A vehicle including the vehicle body of claim 13.
